(19) United States
(12) Patent Application Publication
(10) Pub. No.: US 2005/0175002 A1
(43) Pub. Date: Aug. 11, 2005

(54) Alternative method to the return routability test to send binding updates to correspondent nodes behind firewalls

(75) Inventors: Franck Le, Irving, TX (US); Stefano Faccin, Dallas, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/854,716

(22) Filed: May 27, 2004

Related U.S. Application Data
(60) Provisional application No. 60/542,403, filed on Feb. 9, 2004.

(51) Int. Cl. H04L 12/28; H04L 12/56

(52) U.S. Cl. 370/389; 370/395.3

(57) ABSTRACT

The invention proposes a method for providing traversal of a packet filtering function (D) for information transferred between a first network node (A) and a second network node (B) wherein the second network node (B) is associated with a home network control element (C) and the first network node (A) is protected by the packet filtering function (D), the method comprising the steps of sending (S1) a message including temporary identification information from the second node to the home network control element, sending (S3) a message including at least a part of the temporary identification information from the home network control element to the first node, and preparing (S4-S7) a direct connection between the first node and the second node via the packet filtering function based on the identification information. The invention also proposes corresponding network nodes, a corresponding home network control element and a corresponding network system.

### REFERENCE TO RELATED APPLICATIONS

This application claims priority of U.S. Provisional Patent Application Ser. No. 60/542,403, filed on Feb. 9, 2004. The subject matter of this earlier filed application is hereby incorporated by reference.

### BACKGROUND OF THE INVENTION

1. Field of the Invention

The invention relates to a method and a system for providing traversal of a packet filtering function for information transferred between a first network node and a second network node, wherein the second network node (B) is associated with a home network control element and the first network node is protected by the packet filtering function. In particular, the invention relates to performing a route optimization between a first network node and a second network node, wherein the first network node is protected by a firewall.

2. Description of the Prior Art

The Mobile IPv6 protocol (as described, for example, in the Internet draft “Mobility Support in IPv6” by D. Johnson, C. Perkins and J. Arkko, draft-ietf-mobileip-ipv6-24.txt) allows nodes to remain reachable while moving around in the IPv6 (Internet Protocol version 6) Internet. Thanks to the defined extensions and operations, all IPv6 nodes, whether mobile or stationary can communicate with mobile nodes.

Current firewall technologies however do not support Mobile IPv6, as will be described in the following in detail. Since today most networks deploy firewalls, this may prevent large-scale deployment of the Mobile IPv6 protocol.

One set of the issues is related to the way IP addresses are used in Mobile IP, and the way state information is created and maintained in stateful inspection packet filters. An “internal node” is referred to as the node connected to the network protected by the firewall, and an “external node” is referred to as the node outside the boundaries of the network protected by the firewall.

The following describes how stateful inspection packet filters (i.e., the packet filters of a firewall) work. When a Mobile Node (MN) connects to a TCP (Transmission Control Protocol) socket on another host in the Internet, it provides, at the connection synchronization, the socket (IP address and port) on which it expects to receive a response. This information is more particularly included in the so-called TCP SYN (Synchronization) packet.

When that TCP SYN packet is routed through the firewall, the firewall makes an entry in it's state table containing the destination socket and the response socket, and then forwards the packet to the destination.

When the response comes back, the filter looks up the packet's source and destination sockets in its state table: If they match an expected response, the firewall lets the packet pass. If no table entry exists, the packet is dropped since it was not requested from inside the network.

The filter removes the state table entries when the TCP close session negotiation packets are routed through, or after some period of delay, usually a few minutes. This ensures that dropped connections don't leave table “holes” open.

For UDP (User Datagram Protocol), similar state is created but since UDP is connectionless and the protocol does not have indication of the beginning nor the end of a session, the state is based only on timers.

When a Mobile IP node is communicating with a node behind a firewalI (i.e. protected by the firewall) and tries to execute the Return Routability Test defined in the Mobile IPv6 specifications in order to take advantage of the Route Optimization, the firewall blocks such procedure.

In order to illustrate the problem, a communication between an inner node A (protected by the firewall), and an external mobile node B is assumed:

As specified in the Mobile IP, as described in the above-referenced document, for example, the transport and above layers of the ongoing communications should be based on the Home IP address of B, IP HoA B, and not the local IP address that he might get while roaming in order to support mobility.

The state created in the stateful inspection packet filter in the firewall protecting A is therefore initially based on the IP address of A, IP A, and the home address of the node B, IP HoA B.

If the mobile node B is in its home network, the packets are directly exchanged between the nodes A and B.

However, if the mobile node B is roaming, the session can be maintained thanks to the Home Agent of B and the reverse tunneling mechanism. Packets forwarded by the Home Agent to the node A will have the source IP address indicating the Home IP address of B and the destination IP address indicating the IP address of A. Such packets can thus pass the stateful inspection packet filter in the firewall protecting A.

However, nodes A and B might be close while B's Home agent may be far, resulting in a “trombone effect” that can create delay and degrade the performance.

The Mobile IP specifications have defined the route optimization procedure (for example described in the Internet draft “Mobile IP version 6 Route Optimization Security Design Background” by P. Nikkander, J. Arkko, T. Aura, G. Montenegro and E. Nordmark, Dec. 1, 2003, draft-nikander-mobileip-v6-ro-sec-02) in order to solve this issue, and to send a binding update message. The mobile node should first execute a Return Routability Test (which is also referred to as “Return Routability Procedure”).

This Return Routability Test is illustrated in FIG. 1, wherein it is assumed that no firewall is present. The Mobile Node (MN) B should send a Home Test Init message (HoTI) via its Home Agent (HA) C and a Care of Test Init (CoTI) message directly to its Correspondent Node (CN) A. That is, the CoTI message has as its source address the Care-of address (CoA) of the node B. The HoTI message has the Home IP address of the Mobile node and the Correspondent node IP address as the destination IP address. In order to bypass ingress filtering, as defined in the Mobile IPv6 specifications, the HoTI is tunneled from the MN to its Home Agent. The Home agent will then decapsulate the packet and forward it to the CN. Thus, the HoTI message has as its source address the Home address of the node B, and is sent to the correspondent node A via the Home Agent of B.

On receiving the HoTI message, the Correspondent Node A replies with a Home Test (HoT) message which comprises as parameters a Home Init cookie (which was sent from the node B within the HoTI message), a Home Keygen (key generation) Token and a Home Nonce Index.

The destination address of the HoT message is the Mobile Node's Home address. The message is intercepted by the Home agent of B which tunnels it to the Mobile Node's Care of Address as defined in the Mobile IPv6 specifications.

On receiving the CoTI message, the Correspondent Node A replies with a Care-of Test (CoT) message which comprises as parameters a Care-of Init cookie (which was sent from the node B within the CoTI message), a Care-of Keygen Token and a Care-Of Nonce Index. The destination address of the CoT message is the Care-of Address (CoA) of the node B, i.e., this message is directly transmitted to the Mobile Node B without involving the Home Agent.

However, in case the Correspondent Node A is protected by a firewall, the following problem occurs: The Care of Test Init message is sent from the new CoA of the node B, as described above. Such packet will not match any entry in the stateful inspection packet filter in the firewall (since the filter only knows the HoA) and, as described above, the CoTI message will thus be dropped.

As a consequence, the RRT cannot be completed and Route optimization cannot be applied due to the presence of a firewall. This implies that every packet will have to go through the node B's home agent and tunneled between B's home agent and B, which may significantly affect the performance of the communications as pointed out in [1].

Support for route optimization is not a non-standard set of extensions, but a fundamental part of the protocol. Firewalls however prevent route optimization to be applied by blocking the Return Routability Test messages.

There is currently no solution for the above problem.

Some may suggest to allow RRT messages to pass the firewall and to use some rate limiting mechanisms restricting the number of incoming RRT messages to e.g. n/minutes but such mechanism has some strong drawbacks:
If the number of RRT messages allowed per minute is low, it may cause problems with a communicating mobile node which is moving fast since some RRT messages may be dropped.
Also if the number of RRT messages allowed per minute is low, it may create problems if the protected node is communicating with many end points. If these latter ones are mobile nodes, the number of RRT messages may exceed the number of RRT messages authorized resulting in the drop of some RRT messages.

In addition to these issues, the rate limiting method:
Can create some DoS attacks: a malicious node will just have to send a lot of RRT messages. The max number of authorized messages will be reached blocking potential future valid RRT messages from legitimate nodes.
Can create some overbilling attacks since the protected node will have to pay for the packets sent over the air interface.

Finally relying on rate limiting only to support the RRT procedure with firewalls requires applying rate limiting on packets including Mobility Headers. However the Mobile node may be moving to any new subnet and there is no way to predict the new Care of address. Any malicious node can take advantage of this, to flood the victim with packets including Mobility headers. As explained, this can result in overbilling attacks or in the drop of valid RRT messages, once the maximum number of RRT packets has been reached. This method does not therefore appear acceptable.

### SUMMARY OF THE INVENTION

Hence, it is an object of the present invention to allow route optimization of also within firewalls.

This object is solved by a method for providing traversal of a packet filtering function for information transferred between a first network node and a second network node wherein the second network node is associated with a home network control element and the first network node is protected by the packet filtering function, the method comprising the steps of
sending a message including temporary identification information from the second node to the home network control element,
sending a message including at least a part of the temporary identification information from the home network control element to the first node, and
preparing a direct connection between the first node and the second node via the packet filtering function based on the identification information.

Alternatively, the object is solved by a network system comprising a first network node, a second network node, a home network control element associated with the second network node, and a packet filtering function for protecting the first network node, wherein
the second network node comprises a sending means for sending a message including temporary identification information to the home network control element,
the home network control element comprises a sending means for sending a message including at least a part of the temporary identification information to the first node, and
the first network node comprises a processing means for preparing a direct connection between the first node and the second node via the packet filtering function based on the identification information.

Hence, according to the invention, the necessary temporary identification information (e.g., CoA, Care-of Init cookie) are not sent directly to the first network control element (e.g., a Correspondent Node), but via the home network control element (e.g., Home Agent) of the second network node. Since the message from the home network control element can be sent to the first network control element via an address which is known to the packet filtering function (e.g., a firewall), the necessary information can easily be forwarded to the first network node. After this, the connection can easily be established.

Hence, a route optimization can easily be performed although the first network node is protected by the firewall.

In this context, a “direct connection” between the first and the second node means a connection between the first and the second node without involving the home network control element, i.e., without tunnelling.

The invention also proposes a network node comprising
a receiving means for receiving a message including temporary identification information from a home network control element of another network node, and
processing means for preparing a direct connection to the other network node via a packet filtering function based on the received temporary identification information.

This network node may be a Correspondent Node (CN).

The invention also proposes a network node, wherein
the network node is associated with a home network control element, and comprises
sending means for sending a message including temporary identification information to the home network control element, wherein the temporary information contains information for providing a direct connection to another network node.

This network node may be a Mobile Node having a Home Agent (HA), for example.

Moreover, the invention proposes a home network control element associated with a second network node, comprising
a receiving means for receiving a message including temporary identification information from the second node, and
a sending means for sending a message including at least a part of the temporary identification information to the first node, wherein
the temporary information contains information for providing a direct connection between the first and the second network node.

The temporary identification information described above may comprise a temporary address of the second network node. This temporary address may be a Care-of Address (CoA) of the network node.

The second network node may comprise at least a temporary address and a fixed address, and wherein on sending a message from the home network control element to the first node, the fixed address of the second network node is used as a source address. That is, the message is sent to the first network node via the home agent.

Moreover, the temporary identification information (e.g., the CoA) may be verified in the home network control element may be after receiving the temporary identification information from the second network node and before sending the message to the first network node. In this way, it can be ensured that the message is indeed sent from the second network node. Hence, security can be enhanced.

The message including the temporary identification information may include at least one of a home address of the second network node, a home initialization value, a care-of initialization value and an address of the first network node (A).

The initialization information may include a home initialization value, and/or may include a care-of initialization value.

Upon preparing a direct connection between the first network node and the second network node, token information may be sent from the first network node to the second network node.

The token information may include a Home Keygen token and/or a Care-of Keygen token.

The token information may be sent directly from the first network node to the second network node using the temporary identification information, or may be sent from the first network node to the second network node through the home network control element.

The packet filtering function may creates state information based on the temporary information.

### BRIEF DESCRIPTION OF THE DRAWINGS

The invention is described in the following by referring to the attached drawings in which:

FIG. 1 illustrates a Return Routability Test,

FIG. 2 illustrates a signal flow for the procedure according to a preferred embodiment of the invention, and

FIG. 3 shows a basic structure of the elements involved in the procedure according to the preferred embodiment of the invention.

### DETAILED DESCRIPTION OF THE PREFERRED EMBODIMENT

In the following, a preferred embodiment of the invention is described.

As described above, the present invention defines a new method for a Mobile IP node to securely send Binding Update message to its correspondent nodes (so that Route Optimization can be applied). By secure, it is meant that no new attacks are introduced in comparison to current Internet operations.

As described above, the Mobile IPv6 specifications have defined a procedure, called the Return Routability Test (RRT) to assure that the right mobile node is sending the signaling message. As the RRT, the procedure defined according to the present embodiment of the invention does not require any pre-configured security association, any infrastructure nor any public key.

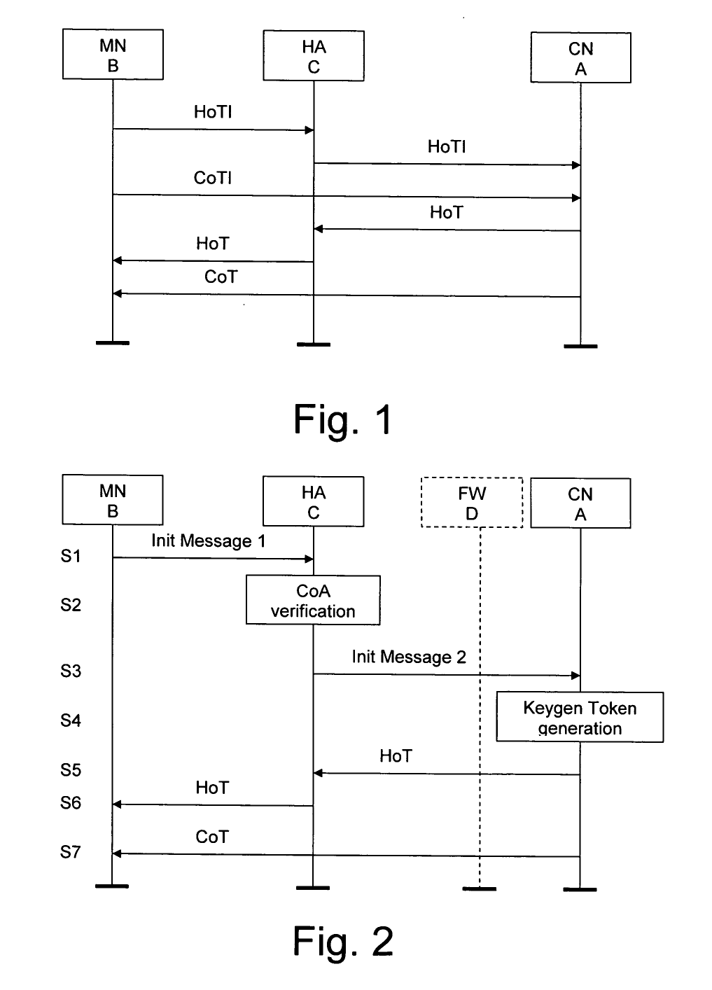

The procedure according to the present embodiment is described in the following by referring to the signal flow chart shown in FIG. 2. Similar as in FIG. 1, a Mobile Node (MN) B is roaming and is associated with a Home Agent (HA) C. The Mobile Node B would like to perform a route optimization with a Correspondent Node A, which is protected by a firewall (FW) D. It is noted that the firewall is indicated in FIG. 2 by a dashed box.

The procedure carried out according to the present embodiment in the arrangement described above is as follows:

1. When changing IP address, in order to send a binding update message to a correspondent node, instead of performing the RRT, the MN should send a message to its Home Agent containing:
a Home Init cookie
a Care-of Init cookie
its Home address
the IP address of the correspondent node
optionally the CoA (it should already be in the source IP address field of the IP packet)

This is illustrated in FIG. 2 in step S1, in which the above message, referred to as “Init Message 1” in the drawings, is sent from the MN B to its Home Agent HA.

2. The Home Agent should verify that the CoA is the one of the MN (with the binding cache previously established through a binding update as in Mobile Ipv6 regular procedures). In FIG. 2, this is illustrated in step S2. If the verification is successful, the Home Agent should send a message to the Correspondent Node A with the following information:
the Home Init cookie
the Care-of Init cookie
the MN's CoA

The source IP address of this message should indicate the MN's HoA, as in regular tunneling through the Home Agent. Namely, since the HoA is known to the firewall, this message is allowed to pass through the firewall.

This is illustrated in FIG. 2 in step S3, in which the above message is referred to as “Init Message 2” being sent to the Correspondent Node A.

3. Upon receiving such message, the CN A, if accepting route optimization to be applied, should generate the Home Keygen Token and the Care-of Keygen token, as illustrated by step S4 in FIG. 2. Then, the Correspondent node A sends the Home Test and Care-of Test messages as specified in Mobile IPv6, i.e., as described above with respect to FIG. 1.

In detail, the Home Test (HoT) message including the Home Keygen Token is sent in step S5 to the HA, which in turn tunnels it to the Mobile Node B (step S6). The Care-of Test (CoT) message including the Care-of Keygen token is sent directly form the Correspondent Node A to the Mobile Node B in step S7.

The source address of the CoT message is set to the address of the Correspondent Node A, whereas the destination address is set to the CoA of the Mobile Node B. By sending the CoT message from the protected node via the firewall, a new state can be created in the packet filter of the firewall, so that now a direct connection between the Correspondent Node A and the Mobile Node B using its CoA can be established.

4. The rest of the procedure should be as in Mobile IPv6 (as described in the above-referenced Internet draft “Mobility Support in IPv6”, for example).

The above procedure can correspondingly be adapted for a handover, when the Mobile Node B gets a new CoA. This new CoA can be notified to the Correspondent Node A as described above, namely by sending the “Init Message 1” to the HoA and the “Init Message 2” to the Correspondent Node A. In this case, however, the filter in the network for the connection with HoA address of the Mobile Node B has to be still valid.

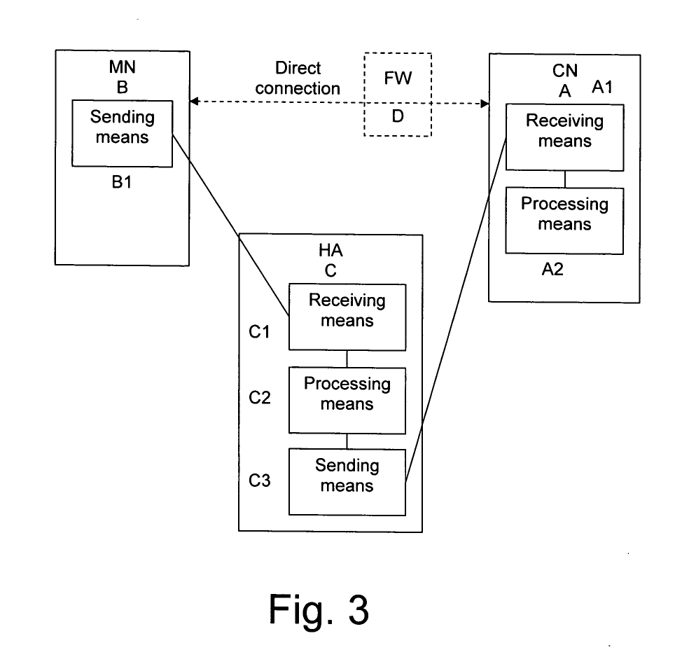

FIG. 3 shows a block diagram illustrating the basic structure of the elements according to the preferred embodiment of the invention. In particular, reference character A denotes the Correspondent Node CN, i.e., the protected, inner node, comprising a receiving means A1 for receiving the Init Message 2 and a processing means for preparing the direct connection to the second network node B (i.e., generating and sending HoT and CoT messages and the like) based on the identification information (i.e., Care-of Address and Care-of Init cookie). Reference character B denotes the second network node comprising sending means B1 for sending the Init Message 1. Reference character C denotes the Home Agent (HA) of the Mobile Node B, comprising a receiving means C1 for receiving the Init Message 1, a processing means C2 for verifying the CoA of the Mobile Node B and generating the Init Message 2 and a sending means C3 for sending the Init Message 2 to the Correspondent Node A.

The Correspondent Node A is protected by a Firewall, as indicated by the dashed box.

Thus, by the procedure according to the present embodiment, the following advantages can be achieved:
This method provides a method to securely send binding updates to correspondent nodes behind firewalls.
This method presents all the same advantages than the RRT (light mechanism, secure mechanism, no required pre-established SA, no required infrastructure, no required Public Keys, etc.).
This method does not introduce any new attacks (such as amplification and/or reflection attacks) compared to the RRT thanks to the verifications performed by the Home Agent (step S2).
This method does not introduce any attacks to the Home Agent (e.g. memory/state exhaustion) thanks to the fact that the Home agent only processes packets sent to its IP address, and only the MN should have such information.
This method requires minor modifications to the MN, HA and CN. The operations/algorithms are the same ones than the RRT one.
The proposed method is actually very similar to the RRT but has the main advantage to be supported by networks protected by firewalls i.e. the method defined in this document can work in presence of firewalls whereas the RRT procedure is blocked by firewall.

This method may require minor modification to the firewalls: More particularly, the firewall should open a pinhole for packets including Mobility Headers, for communicating nodes. In other words, when two nodes are communicating, they should be able to exchange in addition to the data packets, packets including mobility headers.

Rate limiting on the packets containing the Mobility Headers should however be applied to reduce misuses.

Such method prevents malicious nodes from sending packets to the victim. Only packets with valid IP addresses (i.e. IP addresses of communicating nodes) can bypass the firewall.

The above description and accompanying drawings only illustrate the present invention by way of example. Thus, the embodiment and its variations may vary within the scope of the attached claims.

For example, the invention is not restricted to firewalls, but may be applied to any kind of packet filtering functions (access blocking functions) which fulfill a similar function.

Moreover, the invention is not limited to MIP but can be applied to any transport protocols in which one of the node involved in a connection may change its address.

Furthermore, in the above-described embodiment the protected node, i.e., the CN, has a fixed address. However, also the CN may be a mobile node and may change its address.

Furthermore, according to the above embodiment, the Init Messages 1 and 2 were described as a new message including Home Init and Care-of Init cookies. However, as an alternative, the HoTI message sent from the node B to its HA, as shown in FIG. 1, may be modified such that the HoTI message includes not only the Home Init cookie, but also the Care-of Init cookie, the home address of the node B, the IP address of the node A and optionally the CoA. Furthermore, also the HoTI message sent from the HA to the Correspondent Node A may be correspondingly modified, namely such that it contains the Home Init cookie, the Care-of Init cookie and the CoA of the node B, similar to the Init Message 2.

Thus, according to an embodiment of the invention, the problem is handled when an MN is communicating with a CN behind a Firewall and tries to execute the Return Routability Test in order to take advantage of the Route Optimization (RO). In this case, the FW blocks the CoTI message and makes the RRT failed. As a result, RO cannot be applied if CN is shielded by firewall. This problem is solved by a new method which is defined as an alternative to RRT in a firewalled network. Instead of sending HoTI and CoTI messages in RRT procedure, the MN sends a message to its HA, which includes “Home Init cookie”, “Care-of Init cookie”, MN's HoA, CN's address and optionally MN's CoA. After receiving this message, HA verifies that the CoA is the one of the MN. Then HA should send a message to CN containing “Home, Init cookie”, “Care-of Init cookie” and MN's CoA. Upon receiving said message, CN can proceed with the RRT procedure as defined in MIPv6, i.e. generating Home Keygen Token and Core-of Keygen Token and send Home Test and Care-of Test messages, etc.

1. A method for providing traversal of a packet filtering function for information transferred between a first network node and a second network node wherein the second network node is associated with a home network control element and the first network node is protected by the packet filtering function (D), the method comprising the steps of:
sending a first message including temporary identification information from the second node to the home network control element;
sending a second message including at least a part of the temporary identification information from the home network control element to the first node; and
preparing a direct connection between the first node and the second node via the packet filtering function based on the identification information.

2. The method according to claim 1, wherein the temporary identification information comprises a temporary address of the second network node.

3. The method according to claim 1, wherein the second network node comprises at least a temporary address and a fixed address.

4. The method according to claim 3, wherein in the step of sending the second message from the home network control element to the first node, the fixed address of the second network node is used as a source address.

5. The method according to claim 1, further comprising the step of
verifying the temporary identification information in the home network control element after receiving the temporary identification information from the second network node and before sending the message to the first network node.

6. The method according to claim 1, wherein the first message including the temporary identification information includes at least one of a home address of the second network node, an initialization information and an address of the first network node.

7. The method according to claim 6, wherein the initialization information includes a home initialization value.

8. The method according to claim 6, wherein the initialization information includes a care-of initialization value.

9. The method according to claim 1, wherein the step of preparing a direct connection between the first network node and the second network node includes a step of sending token information from the first network node to the second network node.

10. The method according to claim 9, wherein the token information includes a Home Keygen token.

11. The method according to claim 9, wherein the token information includes a Care-of Keygen token.

12. The method according to claim 9, wherein the step of sending token information includes a step of sending information directly from the first network node to the second network node using the temporary identification information.

13. The method according to claim 9, wherein the step of sending token information includes a step of sending information from the first network node to the second network node through the home network control element.

14. The method according to claim 12, wherein the packet filtering function creates state information based on the temporary information.

15. A network node comprising:
receiving means for receiving a message including temporary identification information from a home network control element of another network node, and
processing means for preparing a direct connection to the another network node via a packet filtering function based on the received temporary identification information.

16. The network node according to claim 15, wherein the temporary identification information comprises a temporary address of the another network node

17. The network node according to claim 15, wherein the message including the temporary identification information includes at least one of a home address of the another network node, an initialization information and an address of the network node.

18. The network node according to claim 17, wherein the initialization information includes a home initialization value.

19. The network node according to claim 17, wherein the initialization information includes a care-of initialization value.

20. The network node according to claim 15, wherein the processing means is configured to send token information to the another network node.

21. The network node according to claim 20, wherein the token information includes a Home Keygen token.

22. The network node according to claim 20, wherein the token information includes a Care-of Keygen token.

23. The network node according to claim 20, wherein the processing means is configured to send token information directly the another network node using the temporary identification information.

24. The network node according to claim 20, wherein the processing means is configured to send the token information to the another network node through the home network control element.

25. A network node, wherein
the network node is associated with a home network control element, and comprises
sending means for sending a message including temporary identification information to the home network control element, wherein the temporary information contains information for providing a direct connection to another network node; and
means for providing the direct connection to the another network node.

26. The network node according to claim 25, wherein the temporary identification information comprises a temporary address of the network node.

27. The network node according to claim 25, wherein the message including the temporary identification information includes at least one of a home address of the second network node, a home initialization value, a care-of initialization value and an address of the other network node.

28. The network node according to claim 27, wherein the initialization information includes a home initialization value.

29. The network node according to claim 27, wherein the initialization information includes a care-of initialization value.

30. The network node according to claim 25, wherein further comprising receiving means for receiving token information from the other network node.

31. The network node according to claim 30, wherein the token information includes a Home Keygen token.

32. The network node according to claim 30, wherein the token information includes a Care-of Keygen token.

33. A home network control element associated with a second network node, comprising
receiving means for receiving a message including temporary identification information from the second node; and
sending means for sending a message including at least a part of the temporary identification information to a first node.

34. The home network control element according to claim 33, wherein:
the temporary identification information contains information for providing a direct connection between the first and the second network nodes.

35. The home network control element according to claim 33, wherein the sending means is adapted to send the message to the first network node by using the fixed address of the second network node as a source address.

36. The home network control element according to claim 33, further comprising
verifying means for verifying the temporary identification information received from the second network node.

37. The home network control element according to claim 33, wherein the message including the temporary identification information includes at least one of a home address of the second network node, a home initialization value, a care-of initialization value and an address of the first network node.

38. The home network control element according to claim 37, wherein the initialization information includes a home initialization value.

39. The home network control element according to claim 37, wherein the initialization information includes a care-of initialization value.

40. A network system comprising a first network node, a second network node, a home network control element associated with the second network node, and a packet filtering function for protecting the first network node, wherein:
the second network node comprises a sending means for sending a message including temporary identification information to the home network control element;
the home network control element comprises a sending means for sending a message including at least a part of the temporary identification information to the first network node; and
the first network node comprises a processing means for preparing a direct connection between the first network node and the second network node via the packet filtering function based on the identification information.

41. The network system according to claim 40, wherein the temporary identification information comprises a temporary address of the second network node.

42. The network system according to claim 40, wherein the second network node comprises at least a temporary address and a fixed address, and wherein the sending means of the home network control element is configured to send a message to the first network node by using the fixed address of the second network node as a source address.

43. The network system according to claim 41, wherein the home network control element comprises a verifying means for verifying the temporary identification information in the home network control element received from the second network node.
